(19) United States
(12) Patent Application Publication
(10) Pub. No.: US 2005/0129578 A1
(43) Pub. Date: Jun. 16, 2005

(54) Fast system for detecting detectible combustion products and method for making and using same

(75) Inventor: Franek Olstowski, Houston, TX (US)

Correspondence Address: ROBERT W STROZIER, P.L.L.C, PO BOX 429, BELLAIRE, TX, 77402-0429, US

(73) Assignee: PETROLEUM ANALYZER COMPANY, LP

(21) Appl. No.: 10/970,353

(22) Filed: Oct. 21, 2004

Related U.S. Application Data
(60) Provisional application No. 60/513,123, filed on Oct. 21, 2003.

(51) Int. Cl. G01N 31/12

(52) U.S. Cl. 422/78; 436/160

(57) ABSTRACT

An fast analytical system and associated method is disclosed for analytically quantifying oxides of a sample for a given concentration of a desired element in the sample, where the system includes a sample supply system, an oxidizing agent supply system, a furnace system, a detection chamber, a transfer tube interconnecting the detection chamber and the furnace, where the chamber and the transfer line are maintained at an elevated temperature sufficient to reduce or prevent water vapor condensation in either the reaction chamber or the transfer line.

### BACKGROUND OF THE INVENTION

1. Field of the Invention

The present invention relates to an analytical instrument for fast detection of non-vacuum assisted detectible oxides and methods for making and using same.

More particularly, the present invention relates to an analytical instrument for fast detection of non-vacuum assisted detectible oxides, where the instrument includes a sample supply unit, an oxidizing agent supply unit, a combustion unit maintained at a first elevated temperatue, a transfer line, a detection chamber, a detector and an analyzer, where the transfer line and the detector chamber are maintained at a second elevated temperature, where the first elevated temperature is sufficient to convert all or substantially all of the oxidizable components in a sample to their corresponding oxides and where the second temperature is sufficient to reduce or eliminate water vapor condensation in the transfer line and detector chamber. The present invention also relates to methods for making and using same.

2. Description of the Related Art

Many instruments have been designed to perform on-line studies of compositions in reactor and/or refinery effluents or other effluents. Many of these instruments have considerably long cycle rates with most having cycle time of four (4) minutes or more.

Although many of these systems do an adequate job at monitoring effluent compositions, their considerable cycle time is not sufficient to allow tighter control over reactor, refinery and/or other chemical transformation processes. Thus, there is a need in the art for a faster analytical instrument for detecting and measuring detectible combustion products for non-vacuum assisted detection from effluents from reactors, refineries or other chemical transformation processes to allow improved process control and monitoring.

### SUMMARY OF THE INVENTION

The present invention provides an analytical instrument for fast on-line monitoring of effluents comprised of at least one combustible components detectible by a non-vacuum assisted detection system, where the instrument includes a sample supply system, an oxidizing agent supply system, a combustion chamber maintained at a first elevated temperature, a detection chamber, a transfer line connecting the two chambers, a detector and an analyzer, where the detection chamber and the transfer line are maintained at a second elevated temperature, where the first elevated temperature is sufficient to convert all or substantially all oxidizable sample components into their corresponding oxides and the second elevated temperature is sufficient to prevent or eliminate water vapor condensation in the transfer line and detection chamber.

The present invention also relates to an analytical instrument including a sample supply system, an oxidizing agent supply system, a combustion chamber maintained at a first elevated temperature, a UV fluorescence detection chamber, an excitation light source in optical communication with the detection chamber, a transfer line connecting the two chambers, a photo detector and an analyzer, where the detection chamber and the transfer line are maintained at a second elevated temperature, where the first elevated temperature is sufficient to convert all or substantially all oxidizable sample components into their corresponding oxides and the second elevated temperature is sufficient to prevent or eliminate water vapor condensation in the transfer line and detection chamber.

The present invention relates to a sulfur analytical instrument including a sample supply system, an oxidizing agent supply system, a combustion chamber, a UV fluorescence detection chamber adapted to detect fluorescent light emitted from electronically excited sulfur dioxide, a transfer line connecting the two chambers, a detector adapted to detect the fluorescent light and an analyzer adapted to convert the detected light into a concentration of sulfur in the sample. The combustion chamber is maintained at a first elevated temperature sufficient to convert or oxidize all or substantially all oxidizable sample components into their corresponding oxides. The detection chamber and the transfer line are maintained at a second elevated temperature sufficient to prevent or eliminate water vapor condensation in the transfer line and the detection chamber. The heated transfer line and detector chamber allows a cycle time to be about twice to four times faster than a conventional on-line instrument designed to measure sulfur concentration in samples. In one preferred embodiment, the cycle time of the system of this invention is less than or equal to about 2 minutes. In another preferred embodiment, the cycle time of the system of this invention is less than or equal to about 1.5 minutes. In another preferred embodiment, the cycle time of the system of this invention is less than or equal to about 1 minute. In yet another preferred embodiment, the cycle time of the system of this invention is less than 1 minute. The term cycle time is defined as the elapsed time between sample introduction into the analytical system and the concentration determination in the analyzer. A faster analysis is critical in many chemical and refinery processes and is especially well suited of measuring sulfur content during final fuel formulating and blending.

The present invention relates to a method for rapid determination of a concentration of an element capable of generating a detectible combustion product or oxide, where the method includes the steps of supplying a sample to a combustion chamber of an analytical instrument of this invention and simultaneously, collectively or sequentially supplying an oxidizing agent to the combustion chamber. Once in the combustion chamber, oxidizable components in the sample are converted into their corresponding oxides and water vapor, where the combustion chamber is maintained at a first elevated temperature above an ignition temperature for an oxidizing agent-sample mixture or sufficient to oxidize all or substantially all oxidizable sample components into their corresponding oxides. Generally, the first elevated temperature is above about 300° C., preferably above about 600° C., and particularly above about 900° C. Preferably, the elevate temperature is between about 300° C. and about 2000° C. Particularly, the elevated temperature is between about 600° C. and about 1500° C. More particularly, the elevated temperature is between about 800° C. and about 1300° C. The combustion apparatuses of this invention can be operated at ambient pressure, at reduced pressure down to ten of millimeters of mercury, or at higher than ambient pressures up to a 1000 or more psia. The term substantially all means that at least 95% of the oxidizable components in the combustible material have been converted to their corresponding oxides, preferably, at least 98% of the oxidizable components in the combustible material have been converted to their corresponding oxides, particularly, at least 99% of the oxidizable components in the combustible material have been converted to their corresponding oxides and especially, at least 99.9% of the oxidizable components in the combustible material have been converted to their corresponding oxides.

Transferring the oxidized mixture via a transfer tube to a reaction chamber while maintaining the transfer tube at a second elevated temperature sufficient to reduce or prevent water vapor condensation in the transfer line or the detection chamber. The second elevated temperature is generally between about 30° C. and about 120° C. and preferably between about 40° C. and about 100° C. The method also includes the steps of irradiating the mixture with excitation light from an excitation light source to form electronically excited, detectible oxides, detecting fluorescent light emitted by the electronically excited detectible oxides and deriving a concentration of the detectible oxide, which comprises an element of interest, in the effluent and relate it to a concentration of the element in the sample.

### DESCRIPTION OF THE DRAWINGS

The invention can be better understood with reference to the following detailed description together with the appended illustrative drawings in which like elements are numbered the same:

FIG. 1 depicts a block diagram of a preferred embodiment an apparatus of this invention; and

FIG. 2 depicts a block diagram of a preferred embodiment of a detection system of this invention.

### DETAILED DESCRIPTION OF THE INVENTION

The inventor has found that a fast analytical technique can be developed for rapid systematic analysis of routine samples and especially for systematic analysis and monitoring of reactor effluent compositions or refinery effluent compositions to ensure conformity with either governmental or industrial standards of quality. The technique includes a combustion chamber maintained at a first elevated temperature to ensure complete or substantially complete oxidization or conversion of all oxidizable sample components into their corresponding oxides and water and a post combustion chamber system maintained at a second elevated temperature sufficient to reduce or eliminate water vapor condensation in the post combustion chamber system. The technique also includes a detection system designed to detect and quantify a concentration of an element in the sample from a concentration of a detectible oxide in the combustion products.

The inventor has found that by heating the system downstream of the combustion chamber, the cycle time for sample analysis can be reduced from about 4 minutes per sample to about 1 minute or less. This nearly 4 time reduction in cycle time, the time between each sample injection and an output result, greatly improves monitoring of effluents of chemical and/or refinery processes on-line. For example, the fuel blending is commonly performed by refiners to produce fuel that meets or exceeds governmental levels of sulfur. Generally, the refiners will produce to a very low level sulfur feedstock (expensive) and a high level sulfur feedstock (less expensive). The low level sulfur feedstock has a sulfur content well below governmental standards, while the high level sulfur feedstock has a sulfur content well above governmental standards. The refiners then blend the two feedstocks together in a ratio designed to generate a blended feedstock having a sulfur level at or slightly below the governmental standard. However, to do this blending and maintain the desired sulfur level, the refiners need fast and accurate analytical data. The faster the accurate analytical data the better because a few minutes of producing an out-of-spec material cost refiners a lot of money and lowers throughput—the out-of-spec product must be reblended to a desired low sulfur content. Therefore, fast and accurate analytical data can improve product conformity, uniformity and product throughput. Of course, the need to monitor output composition quickly is sought in many industrial areas including the chemical industry, the pharmaceutical industry, the nutraceutical industry, and the food industry to name a few.

The present invention broadly relates to an improved analytical instrument for rapid and accurate sample analysis including a combustible material (fuel or sample) supply system, an oxidizing agent supply system (of course, the two systems can be combined into a single supply system) and a combustion chamber. The combustible material supply system supplies the sample to the combustion chamber, while the oxidizing agent supply system supplies an amount of an oxidizing agent sufficient to completely or substantially completely oxidize all oxidizable components in the sample to their corresponding oxides. The combustion chamber, which is maintained at a first elevated temperature sufficient to promote complete or substantially complete combustion, oxidizes the oxidizable components of the sample into their corresponding oxides and water forming an oxidized mixture. The mixture is then transferred to a reaction chamber via a transfer line. The transfer line and the reaction chamber are maintained at a second elevated temperature. In the reaction chamber, one or more oxides in the mixture are detected and a concentration of an element in each of the oxides is determined and converted to a concentration of that element in the sample. In the reaction system, the oxidizes are generally exposed to an agent that causes the oxides to be converted to an analytically active state. The preferred agent is excitation light and the preferred analytically active state is an electronically excitation state. Thus, the preferred detection system is a light amplification device such as a photo-multiplier tube (PMT) or any other photo-counting device that produces an electronic signal proportional to the concentration of the oxide of interest in the mixture such as a Charge-coupled Device (CCD) or an Intensitifed Charge Coupled Devise (ICCD).

The sample supply system can be any sample supply system including an auto-sampler, a septum for direct injection, a sampling loop for continuous sampling, an analytical separation system such as a GC, LC, MPLC, HPLC, LPLC, or any other sample supply system used now or in the future to supply samples to analytical instrument combustion chambers or mixture or combinations thereof.

The present invention broadly relates to a method for fast and accurate sample analysis including the steps of feeding a combustible composition and an amount of oxidizing agent in excess of all combustible components of the combustible composition to a combustion chamber maintained at a first elevated temperature sufficient to covert all of the combustible components in the combustible composition completely or substantially completely, preferably completely, to their corresponding oxides and water to produce an oxidized mixtures. Transferring the oxidized mixture to a reaction chamber via a transfer line, where the transfer line and reaction chamber are maintained at a second elevated temperature sufficient to reduce or prevent water vapor condensation in the transfer line or the reaction chamber. Exposing the mixture in the reaction chamber to an agent that converts a portion of at least one oxide in the mixture to an analytically active state. Measuring the at least one oxide in its analytically active state to produce a signal proportional to a concentration of the at least one oxide in its analytically active state. Converting this signal into a concentration of an element in the sample, where the element is an atomic constituent of the at least one oxide. A cycle time for the entire process represents a reduce period of time, up to four times faster than traditional methods, with equivalent or better accuracy.

The combustion chamber useful in this invention can be any conventional packed or unpacked combustion tube. However, one preferred combustion chamber for use in this invention is a combustion chamber having a combustion zone with at least one static mixer along a length of the combustion zone for increasing oxidation efficiency without increasing a combustion volume and/or a residence time in the combustion zone. The mixing combustion chamber can also be used to increase throughput.

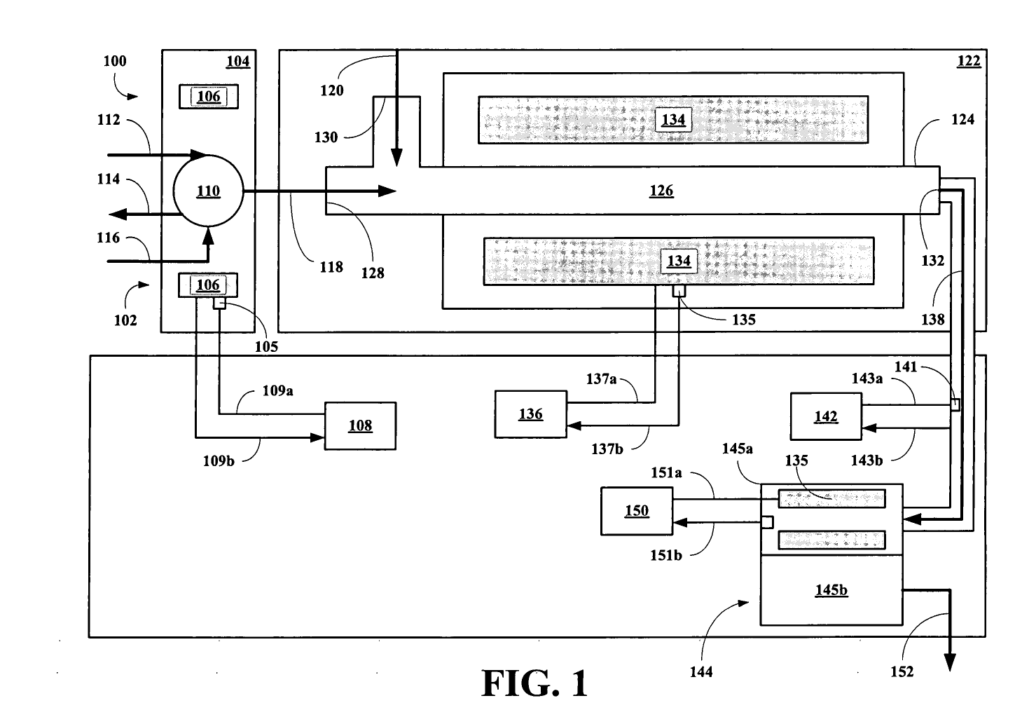

Referring now to FIG. 1, a preferred embodiment of an instrument of this invention, generally 100, is shown to include a sample supply unit 102. The sample supply unit 102 includes a heated sample valve housing 104 including a first heater 106 having a temperature sensor 107 and a first heater temperature controller 108 having a power supply line 109a and a temperature sensor line 109b, and a sample valve 110 having a sample in line 112, a sample out line 114, a carrier gas in line 116 and a sample valve outlet line 118. The first heater 106 and the first controller 108 are designed to maintain the sample supply unit 102 at an elevated injection temperature to allow for adequate sample injection. The instrument 100 also includes an oxidizing agent supply line 120 connected to a source of oxidizing agent (not shown) and a furnace 122 having a combustion tube or chamber 124 including a combustion zone 126. The combustion chamber 124 also includes a sample inlet 128 connected to the sample valve out line 118, an oxidizing agent inlet 130 connected to the oxidizing agent supply line 120 and an oxidized sample outlet 132. The furnace 122 also includes a second heater 134 having a second temperature sensor 135, where the second heater surrounds the combustion zone 126 and a second temperature controller 136 having a power supply line 137a and a temperature sensor line 137b. The second heater 134 and the second controller 136 are adapted to maintain a temperature of the combustion zone 126 at a temperature sufficient to convert all or substantially all oxidizable components in the sample into their corresponding oxides and water forming an oxidized mixture which exits the chamber 124 via the outlet 132.

After the oxidized mixture exits the combustion chamber outlet 132 it enters a transfer line or tube 138 having a third heater 140 including a third temperature sensor 141, where the third heater surrounds all or a majority of a length of the transfer line or tube 138 and a third temperature controller 142 having a power supply line 143a and a temperature sensor line 143b. The third heater 140 and the third controller 142 are designed to maintain the transfer line or tube 138 at a temperature sufficient to prevent or eliminate water vapor condensation in the transfer tube 138. The transfer tube 138 is connected to a detector system 144 having a detector chamber 145a and an detector/analyzer 145b via a detector chamber inlet 146. The detector chamber 145a includes a fourth heater 148 having a fourth temperature sensor 149 and a fourth temperature controller 150 having a power supply line 15la and a temperature sensor line 151b and a vent line 152. The fourth heater 148 and the fourth controller 150 are designed to maintain the detector chamber 145a at an elevated temperature sufficient to prevent or eliminate water vapor condensation in the detector chamber 145a. The detector/analyzer 145b is adapted to convert a single produced in the reaction chamber 145a into a concentration of an oxide in the oxidized mixture and convert that concentration of an element concentration in the sample of the element of interest in the detected oxide. The preferred heater for the transfer tube or line is to heat trace the line with a heating sleeve.

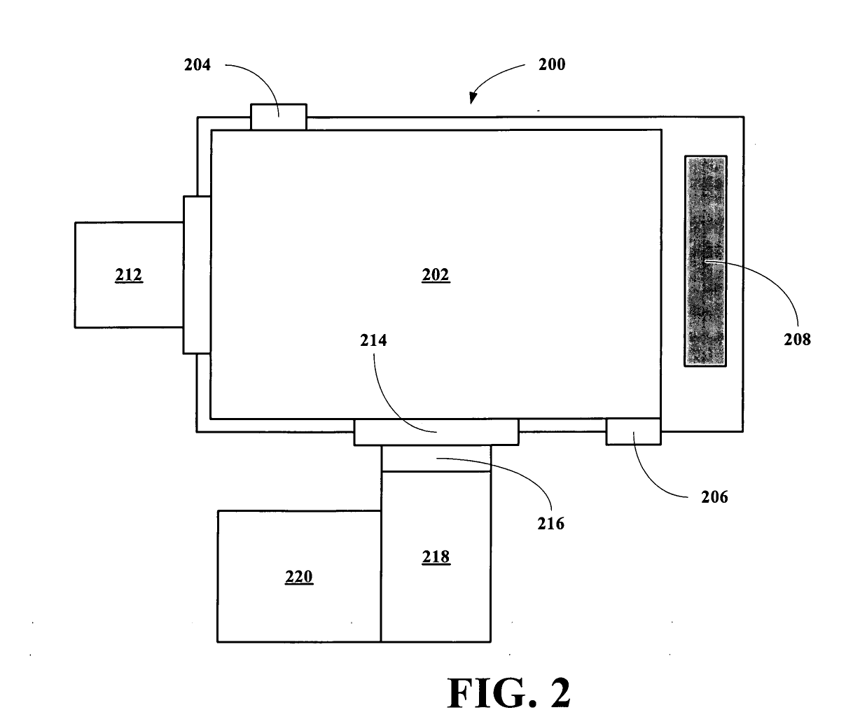

Referring now to FIG. 2, a preferred embodiment of a UV detection system of this invention, generally 200, is shown to include a detector chamber 202, a detector chamber oxidized sample inlet 204, a detector chamber outlet or vent 206 and a detector chamber heater 208. The detector chamber 202 also includes a excitation light port 210 connected to an excitation light source 212 and a detector port 214. The UV detection system 200 also includes a filter 216 and a detector 218, where the filter 216 is connected to the detector port 214 so that a desired bandwidth of UV fluorescent light emitted from oxides in the sample excited by light from the light source 212 and where the detector 218 converts the light passing through the filter 216 into an output signal. The UV detection system 200 also includes an analyzer 220 adapted to convert the output signal from the detector 218 into a concentration of an element in the sample. The preferred elements are sulfur and/or nitrogen. If both nitrogen and sulfur are to be analyzed simultaneous, then the oxidized sample can be split into two parts, one part going to a sulfur detection system and the other part going to a nitrogen detection system. The analyzer is generally a digital processing system including a digital processing unit, memory (cache, RAM, ROM, etc.), a mass storage device, peripheral or the like. The analyzer takes as input the output from the detector such as a PMT and converts the signal into a concentration of an element of interest in the original sample. The data can then be displayed, printed, or the like.

All references cited herein are incorporated by reference. While this invention has been described fully and completely, it should be understood that, within the scope of the appended claims, the invention may be practiced otherwise than as specifically described. Although the invention has been disclosed with reference to its preferred embodiments, from reading this description those of skill in the art may appreciate changes and modification that may be made which do not depart from the scope and spirit of the invention as described above and claimed hereafter.

1. An apparatus for fast detection of a sample comprising:
a furnace system including a combustion zone having an inlet and an outlet and a heater adapted to maintain the combustion zone at a first elevated temperature;
a sample supply system adapted to supply a sample to the combustion zone inlet;
an oxidizing agent supply system adapted to supply an oxidizing agent to the combustion zone inlet;
a detection system including:
a detection chamber having
a detection chamber inlet, and
a detection chamber outlet,
a transfer line interconnecting the combustion outlet and the detection chamber inlet, a heater system adapted to maintain the detection chamber and the transfer tube at a second elevated temperature,
a detector adapted to detect a detectable property of at least one oxide in the oxidized mixture, and
an analyzer adapted to convert an output from the detector into a concentration of an element in the sample,
where the first elevated temperature is sufficient to oxidize all or substantially all oxidizable sample components to their corresponding oxides and water and the second elevated temperature is sufficient to prevent or eliminate water vapor condensation in the transfer line and the detection chamber.

2. The apparatus of claim 1, wherein the detection system further includes an excitation source in optical communication with an excitation light source port of the detection chamber, wherein the detector is a photo detector and wherein the detectable property is UV fluorescent light emitted from at least one oxide in an electronically excited state.

3. The apparatus of claim 1, wherein the sample comprises a fuel.

4. The apparatus of claim 3, wherein the fuel is selected from the group consisting of gasoline, kerosine, jet fuel, diesel fuel, other hydrocarbon based fuels and mixtures or combinations thereof.

5. The apparatus of claim 1, wherein the sample comprises a chemical reactor stream.

6. The apparatus of claim 1, wherein the sample comprises a refinery stream.

7. The apparatus of claim 1, wherein the element is selected from the group consisting of nitrogen, sulfur and mixtures or combinations thereof.

8. The apparatus of claim 1, wherein the element is sulfur.

9. The apparatus of claim 1, wherein the element is nitrogen.

10. The apparatus of claim 2, wherein the element is nitrogen, sulfur or mixtures or combinations thereof.

11. The apparatus of claim 2, wherein the element is sulfur.

12. The apparatus of claim 2, wherein the element is nitrogen.

12. The apparatus of claim 1, wherein a cycle time of the apparatus is at least 2 times less than a cycle time for a system in the absence of a heated transfer line and a heated detection chamber.

13. The apparatus of claim 1, wherein a cycle time of the apparatus is at least 3 times less than a cycle time for a system in the absence of a heated transfer line and a heated detection chamber.

14. The apparatus of claim 1, wherein a cycle time of the apparatus is at least 4 times less than a cycle time for a system in the absence of a heated transfer line and a heated detection chamber.

15. The apparatus of claim 1, wherein a cycle time of the apparatus is less than or equal to 2 minutes.

16. The apparatus of claim 1, wherein a cycle time of the apparatus is less than or equal to 1 minute.

17. The apparatus of claim 1, wherein a cycle time of the apparatus is less than 1 minute.

18. The apparatus of claim 1, wherein the sample supply system is selected from the group consisting of an auto-sampler, a septum for direct injection, a sampling loop for continuous sampling, an analytical separation system and mixture or combinations thereof.

19. The apparatus of claim 1, wherein the analytical separation system is selected from the group consisting of a GC, an LC, an MPLC, an HPLC, an LPLC, and mixtures or combinations thereof.

20. An apparatus for fast detection of a sample comprising:
a sample supply unit;
an oxidizing agent supply unit;
a furnace including:
a combustion zone and
a heater adapted to maintain the combustion zone at a temperature sufficient to oxidize oxidizable components of the sample into their corresponding oxides and water forming an oxidized mixture; and
a detection system including:
a detection chamber,
a transfer tube interconnecting the furnace and the detection chamber,
an excitation source in optical communication with the detection chamber,
a photo detector in optical communication with the detection chamber for detecting UV fluorescent light emitted from the at least one oxide in an electronically excited state and
an analyzer adapted to convert an output of the photo detector into a concentration in the sample of an element of the at least one oxide.

21. The apparatus of claim 20, wherein the sample is a fuel.

22. The apparatus of claim 21, wherein the fuel is gasoline, kerosine, jet fuel, diesel fuel, or any other hydrocarbon based fuel.

23. The apparatus of claim 20, wherein the sample is an effluent from a chemical reactor.

24. The apparatus of claim 20, wherein the sample is a refinery stream.

25. The apparatus of claim 20, wherein the element is nitrogen, sulfur or mixtures or combinations thereof.

26. The apparatus of claim 20, wherein the element is sulfur.

27. The apparatus of claim 20, wherein the element is nitrogen.

28. The apparatus of claim 20, wherein a cycle time from sample introduction to concentration determination is 2 or more times less than a system in the absence of a heated transfer line and a heated detection chamber.

29. The apparatus of claim 20, wherein a cycle time from sample introduction to concentration determination is 3 or more times less than a system in the absence of a heated transfer line and a heated detection chamber.

30. The apparatus of claim 20, wherein a cycle time from sample introduction to concentration determination is 4 or more times less than a system in the absence of a heated transfer line and a heated detection chamber.

31. The apparatus of claim 20, wherein a cycle time from sample introduction to concentration determination is less than or equal to 2 minutes.

32. The apparatus of claim 20, wherein a cycle time from sample introduction to concentration determination is less than or equal to 1 minute.

33. The apparatus of claim 20, wherein a cycle time from sample introduction to concentration determination is less than 1 minute.

34. A method comprising the steps of:
feeding a sample to an apparatus comprising:
a sample supply unit;
an oxidizing agent supply unit;
a furnace including:
a combustion zone and
a heater adapted to maintain the combustion zone at a temperature sufficient to oxidize oxidizable components of the sample into their corresponding oxides and water;
a detection system including:
a detection chamber,
a transfer tube interconnecting the furnace and the detection chamber,
an excitation source in optical communication with the detection chamber,
a photo detector in optical communication with the detection chamber for detecting UV fluorescent light emitted from the at least one oxide in an electronically excited state and
an analyzer adapted to convert an output of the photo detector into a concentration in the sample of an element of the at least one oxide,
oxidizing the oxidizable components of the sample into their corresponding oxides and water forming an oxidized mixture;
forwarding the oxidized mixture to the detection chamber,
exciting at least one oxide in the oxidized mixture with excitation light, and
determining a concentration of an element in the sample from an intensity of light emitted by the excited at least on oxide.

35. The method of claim 34, wherein the sample is a fuel.

36. The method of claim 35, wherein the fuel is gasoline, kerosine, jet fuel, diesel fuel, or any other hydrocarbon based fuel.

37. The method of claim 34, wherein the sample is an effluent from a chemical reactor.

38. The method of claim 34, wherein the sample is a refinery stream.

39. The method of claim 34, wherein the element is nitrogen, sulfur or mixtures or combinations thereof.

40. The method of claim 34, wherein the element is sulfur.

41. The method of claim 34, wherein the element is nitrogen.

42. The method of claim 34, wherein a cycle time from sample introduction to concentration determination is 2 or more times less than a system in the absence of a heated transfer line and a heated detection chamber.

43. The method of claim 34, wherein a cycle time from sample introduction to concentration determination is 3 or more times less than a system in the absence of a heated transfer line and a heated detection chamber.

44. The method of claim 34, wherein a cycle time from sample introduction to concentration determination is 4 or more times less than a system in the absence of a heated transfer line and a heated detection chamber.

45. The method of claim 34, wherein a cycle time from sample introduction to concentration determination is less than or equal to 2 minutes.

46. The method of claim 34, wherein a cycle time from sample introduction to concentration determination is less than or equal to 1 minute.

47. The method of claim 34, wherein a cycle time from sample introduction to concentration determination is less than 1 minute.
